(19) United States
(12) Patent Application Publication
(10) Pub. No.: US 2005/0162394 A1
(43) Pub. Date: Jul. 28, 2005

(54) Mode switch apparatus implemented with a capacitive touchpad for an optical mouse

(76) Inventors: Yen-Chang Chiu, Linkou Shiang (TW); Yung-Lieh Chien, Taoyuan City (TW); Cheng-Hao Tang, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/030,091

(22) Filed: Jan. 7, 2005

(30) Foreign Application Priority Data
Jan. 12, 2004 (TW) 093100716

(51) Int. Cl. G09G 5/08

(52) U.S. Cl. 345/166

(57) ABSTRACT

A mode switch apparatus for an optical mouse comprises a capacitive touchpad mounted on a housing of the optical mouse, and a microprocessor connected to the capacitive touchpad. When a user's hand touches or leaves the capacitive touchpad, a signal representative of capacitance change is generated in response thereto, and the microprocessor switches the optical mouse from a first mode to a second mode, or from the second mode to the first mode, in response to the signal representative of capacitance change.

### FIELD OF THE INVENTION

The present invention is related generally to an optical mouse, and more particularly, to a mode switch apparatus implemented with a capacitive touchpad for an optical mouse.

### BACKGROUND OF THE INVENTION

Optical mouse employs light-emitting diode (LED) as the light source. However, LED consumes high electric power. To reduce the consumed power, the operation modes for optical mouse are regulated as a normal operation mode and a low power mode. In this case, after an idle duration, an optical mouse will be automatically switched from the normal operation mode to the low power mode, so as to reduce the frequency and the number of times to sense the movement of the optical mouse. Under the low power mode, the optical mouse may be switched back to the normal operation mode upon a trigger performed by a wake-up function.

In a conventional wake-up function, it is the button pressed to trigger the optical mouse to wake up. In another conventional wake-up function, it is the light reflected by the surface the optical mouse is operating thereon to be detected and computed by the optical sense integrated circuit of the optical mouse to determine whether or not the optical mouse is moved, so as to generate the wake-up signal for the optical mouse.

During the operations of a conventional optical mouse, the LED within the optical mouse provides enough light intensity for the optical sense integrated circuit of the optical mouse to detect, and it requires a consumed current of about 10-100 mA under the normal operation mode. Even under the low power mode, in which the frequency and the number of times to sense the movement of the optical mouse are reduced, it still requires a consumed current of about 1-10 mA to provide enough light intensity for the optical sense integrated circuit of the optical mouse to detect, and it does not meet the requirement of the green integrated circuit.

In accordance with the USB (Universal Serial Bus) specification, the average consumed current of an optical mouse in a low power mode supported by a wake-up function could not over 2.5 mA. It is therefore impossible for conventional optical mice to support the wake-up function in the low power mode under the restriction of the USB standard, since the conventional optical mice could not consume so low power. To meet the low power requirement, the wake-up function of the conventional optical mouse could be only achieved by the button pressing, rather than by the movement of the optical mouse.

Generally, when a user does not operate an optical mouse, his hand will leave the optical mouse, and in this situation, the optical mouse will not move, by which it could determine the optical mouse is under used or not. Once the optical mouse is determined to be idle, it will be automatically switched from the normal operation mode to the low power mode. When a user intends to use the optical mouse, his hand will touch the optical mouse first, by which the optical mouse will move, and then the host could be waked up. During the wake-up process, apparently, the hand will touch the optical mouse first, and then the optical mouse is moved in X and Y axes. Conventional optical mice only have the wake-up function, and lack of bi-directional mode switch function. In particular, when a user's hand leaves an optical mouse, the optical mouse could not be switched from the normal operation mode to the low power mode instantly or more quickly, and it is necessary to wait for a constant duration to determine the idle state before switching to the low power mode.

Therefore, it is desired a mode switch apparatus for an optical mouse for low power requirement and bi-directional mode switch function.

### SUMMARY OF THE INVENTION

One object of the present invention is to provide a mode switch apparatus implemented with capacitive touchpad for an optical mouse to reduce the power consumption of the optical mouse.

Another object of the present invention is to provide a mode switch apparatus implemented with capacitive touchpad for an optical mouse to perform bi-directional mode switch of the optical mouse.

For an optical mouse, according to the present invention, a mode switch apparatus comprises one or more capacitive touchpads mounted on the housing of the optical mouse, and a microprocessor connected to the capacitive touchpads. When a user's hand touches or leaves the capacitive touchpads, a signal representative of capacitance change is generated in response thereto, and the microprocessor switches the optical mouse from a first mode to a second mode, or from the second mode to the first mode, in response to the signal representative of capacitance change.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a diagram of an optical mouse according to one embodiment of the present invention;

FIG. 2 shows a functional block diagram according to one embodiment of the present invention; and

FIG. 3 shows a diagram of a mechanism for an optical mouse according to one embodiment of the present invention.

### DETAILED DESCRIPTION OF THE INVENTION

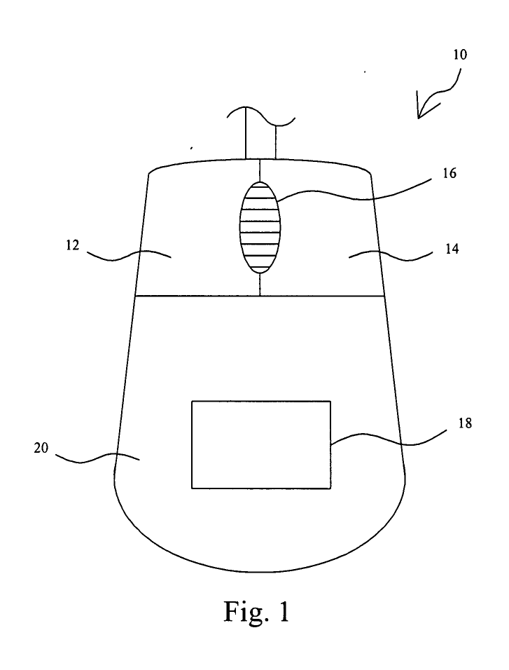

FIG. 1 shows a diagram of an optical mouse according to one embodiment of the present invention. An optical mouse 10 comprises a normal operation mode and a low power mode, and on the housing of the optical mouse 10, two buttons 12 and 14 and a mechanical wheel 16 therebetween are provided as a typical mouse. A capacitive touchpad 18 is further mounted on the hand-held region 20 of the optical mouse 10 for the mode switch function for the optical mouse 10. When the optical mouse 10 is under used, the hand of the user touches on the capacitive touchpad 18, since it is mounted on the hand-held region 20 of the optical mouse 10. When the user stops to use the optical mouse 10, his hand will leave the optical mouse 10, and accordingly, the capacitive touchpad 18 generates a signal representative of capacitance change in response to the leaving of the user's hand from the capacitive touchpad 18, by which the optical mouse 10 could be switched from the normal operation mode to a low power mode, or stop scanning or detecting instantly or in a short duration. On the contrary, when the user or any other intends to use the optical mouse 10, his hand will touch the optical mouse 10 first, and accordingly, the capacitive touchpad 18 generates a signal representative of capacitance change in response to the touch of the user's hand on the capacitive touchpad 18, by which the optical mouse 10 could be switched back to the normal operation mode instantly. In other embodiments, more than one capacitive touchpad could be mounted on the housing of an optical mouse, or one or more capacitive touchpads could be mounted on any one or more regions of the housing of an optical mouse that could be touched. For the low power mode of the optical mouse 10, there may be provided with several modes, for example, a standby mode as the first low power mode, and a sleep mode as the second low power mode. Furthermore, in the normal operation mode, handwriting recognition or other additional functions may be provided by the capacitive touchpad 18, so as to enhance the value-added.

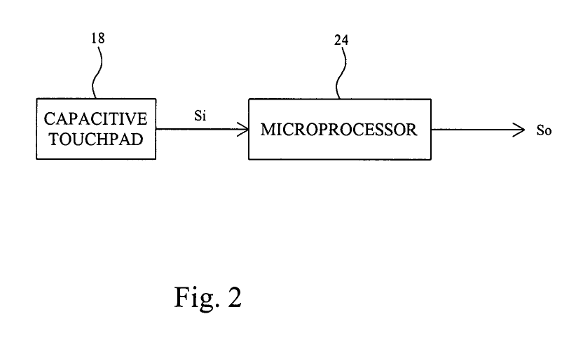

FIG. 2 shows a functional block diagram according to one embodiment of the present invention, to perform the aforementioned mode switch operations realized by the capacitive touchpad 18. In response to a hand touching thereon or leaving therefrom, the capacitive touchpad 18 generates a signal Si representative of capacitance change, and a microprocessor 24 receives the signal Si and generates an output So accordingly, for a mode switch signal for the optical mouse 10 to be either switched from the normal operation mode to the low power mode, or switched back to the normal operation mode from the low power mode. Under the standby mode, the capacitive touchpad 18 consumes extremely low power, and therefore meets the low power requirement for the green integrated circuit or any others. Moreover, there have been well-developed fabrication and operation technologies for the capacitive touchpad, and the capacitive touchpad has a high recognition rate, thereby not requiring much cost for the fabrication of the optical mice and to enhance the recognition rate of the capacitive touchpads on the optical mice. Furthermore, the capacitive touchpad has a thickness only as that of a printed circuit board (PCB), which requires a tiny space in a product, and the capacitive touchpad will not degrade even after a long-term usage.

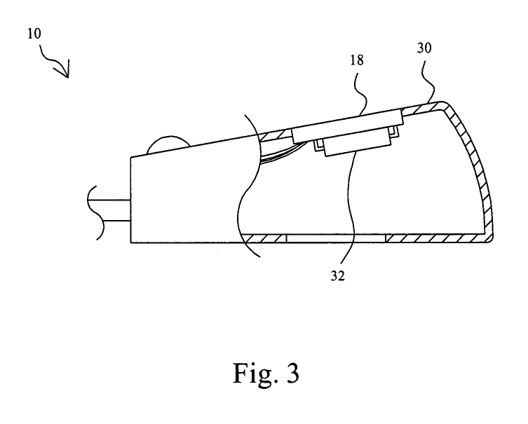

FIG. 3 shows a diagram of a mechanism for an optical mouse according to one embodiment of the present invention. In the optical mouse 10, the capacitive touchpad 18 is mounted on a housing 30 at any where could be touched thereon, and a microprocessor 32 is mounted on the backside of the capacitive touchpad 18 within the housing 30. Various known or improved technologies for capacitive touchpads may be used for or in the capacitive touchpad 18, which may include handwriting recognition function, button-type input function, and so on. In one embodiment, when the optical mouse 10 operates in a normal operation mode, except for the mode switch function, a handwriting recognition function or other additional functions are also provided by the capacitive touchpad 18, and the optical mouse 10 is switched from the normal operation mode to a low power mode upon the leaving of the user's hand from the capacitive touchpad 18. When the user's hand is slipping on the capacitive touchpad 18, the capacitive touchpad 18 is operated for handwriting recognition. When the optical mouse 10 operates in the low power mode, the capacitive touchpad 18 provides a wake-up function, and the optical mouse 10 will be switched back to the normal operation mode by touching on the capacitive touchpad 18 with hand. To switch the optical mouse 10 between or among different modes, the capacitive touchpad 18 serves as a mode switch apparatus. While in the normal operation mode, the capacitive touchpad 18 serves as a handwriting plate, one or more buttons, or other functional devices, for value-added.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

1. A mode switch apparatus for an optical mouse, comprising:
a capacitive touchpad mounted on a housing of the optical mouse for generating a signal representative of capacitance change in response to a hand touching thereon or leaving therefrom; and
a microprocessor connected to the capacitive touchpad for switching the optical mouse from a first mode to a second mode, or from the second mode to the first mode, in response to the signal representative of capacitance change.

2. The mode switch apparatus of claim 1, wherein the first mode is a normal operation mode, and the second mode is a low power mode.

3. The mode switch apparatus of claim 1, wherein the capacitive touchpad performs a function of handwriting recognition under the first mode.

4. The mode switch apparatus of claim 2, wherein the low power mode includes a standby mode and a sleep mode.
